(19) United States
(12) Patent Application Publication
(10) Pub. No.: US 2015/0134474 A1
(43) Pub. Date: May 14, 2015

(54) METHOD AND SYSTEM FOR RECOMMENDING TOURIST ATTRACTIONS BASED ON MEDICAL SERVICES

(71) Applicant: INSTITUTE FOR INFORMATION INDUSTRY, TAIPEI (TW)

(72) Inventors: Yu-Shian CHIU, Taoyuan County (TW); Hui-I HSIAO, Yunlin County (TW); Cheng-Yu TSAI, Taipei City (TW)

(73) Assignee: INSTITUTE FOR INFORMATION INDUSTRY, TAIPEI (TW)

(21) Appl. No.: 14/082,204

(22) Filed: Nov. 18, 2013

(30) Foreign Application Priority Data
Nov. 11, 2013 (TW) 102140913

(51) Int. Cl. G06Q 50/14; G06Q 30/06

(52) U.S. Cl. CPC G06Q 50/14; G06Q 30/0631
USPC 705/26.7

(57) ABSTRACT

A method for recommending tour attractions based on medical services includes steps of choosing at least one medical service from a plurality of medical services; calculating suitability between the at least one medical service and tourist attractions based on medical degree parameters and tour degree parameters; and recommending at least one tourist attraction from a plurality of tourist attractions based on the suitabilities. Furthermore, a system for recommending tourist attractions based on medical services is also disclosed herein.

### RELATED APPLICATIONS

This application claims priority to Taiwan Application Serial Number 102140913, filed Nov. 11, 2013, which is herein incorporated by reference.

### BACKGROUND

1. Field of Invention

The present invention relates to a recommending method and system. More particularly, the present invention relates to a method and system for recommending tourist attractions based on medical services.

2. Description of Related Art

With the development of economy and the progress of society, modern people not only work for a living, but also pay more attention to the quality of life. In addition to higher requirement in basic necessities of life, the demand for domestic and international tourism is increasing and the medical level is more emphasized.

Traditional international medical service merely focuses on the arrangement of the medical service, but does not provide any tour plan. Moreover, traditional international medical service may not recommend any suitable tour schedule according to the medical service so that it may not satisfy modern consumer's requirement for tours and medical services.

Consequently, there still are some inconveniences and disadvantages to be improved in conventional medical service. To solve the problems above, people in this art look for the solution diligently for a long time. However, no suitable solution is found till now.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose to present some concepts disclosed herein in a simplified form as a prelude to the more detailed description that is presented later.

One aspect of this invention is to provide a method and system for recommending tourist attractions based on medical services to improve the problems in prior art.

To achieve the aspect above, this invention discloses a method for recommending tourist attractions based on medical services including the steps as below:

choosing at least one medical service from a plurality of medical services, wherein the medical services include a plurality of medical degree parameters;

calculating a plurality of suitabilities between the at least one medical service and each of tourist attractions based on the medical degree parameters and a plurality of tour degree parameters of the tourist attractions; and

recommending at least one tourist attraction from the tourist attractions based on the suitabilities.

According to one embodiment of this invention, the step of recommending at least one tourist attraction from the tourist attractions based on the suitabilities further includes recommending the tourist attraction with the highest suitability based on the suitabilities.

According to another embodiment of this invention, the method for recommending tourist attractions based on medical services further includes establishing a database to store the medical services and the tourist attractions.

According to further another embodiment of this invention, the method for recommending tourist attractions based on medical services further includes:

choosing at least one tourist attraction from the tourist attractions;

calculating a suitability between the at least one medical service which is chosen and the at least one tourist attraction which is chosen; and

displaying the suitability between the at least one medical service which is chosen and the at least one tourist attraction which is chosen.

According to yet another embodiment of this invention, the method for recommending tourist attractions based on medical services further includes setting the medical degree parameters and the tour degree parameters.

According to another embodiment of this invention, the step of setting the medical degree parameters and the tour degree parameters includes analyzing an input meaning to set the medical degree parameters and the tour degree parameters.

According to another embodiment of this invention, the step of setting the medical degree parameters and the tour degree parameters includes analyzing an input meaning to determine whether the medical degree parameters and the tour degree parameters need to be set reversely.

According to another embodiment of this invention, the step of setting the medical degree parameters and the tour degree parameters includes analyzing an input meaning to obtain at least one keyword, and setting the medical degree parameters and the tour degree parameters according to the keyword.

According to another embodiment of this invention, the medical degree parameters include a preset recovering time of operations, a preset notice item of foods and a preset notice item of tourism.

According to another embodiment of this invention, the tour degree parameters include a preset exercise degree parameter, a preset food degree parameter and a preset tour degree parameter.

To achieve the aspect above, this invention also discloses a system for recommending tourist attractions based on medical services including a user interface providing module, a calculating module and a display module. The user interface providing module is configured to provide a user interface containing a plurality of medical services. Thus, the user may select at least one of the medical services from the user interface and the medical services include a plurality of medical degree parameters. The calculating module is configured to calculate a plurality of suitabilities between the at least one medical service and each of tourist attractions based on the medical degree parameters and a plurality of tour degree parameters of the tourist attractions.

The display module is configured to display and recommend at least one of the tourist attractions based on the suitabilities.

According to one embodiment of this invention, the display module is further configured to recommend the tourist attraction with the highest suitability based on the suitabilities.

According to another embodiment of this invention, the system for recommending tourist attractions based on medical services further includes a database configured to store the medical services and the tourist attractions.

According to further another embodiment of this invention, the user interface providing module is further configured to let a user choose at least one of the tourist attractions. The calculating module is further configured to calculate the suitability between the at least one medical service which is chosen and the at least one tourist attraction which is chosen. The display module is further configured to display the suitability between the at least one medical service which is chosen and the at least one tourist attraction which is chosen.

According to yet another embodiment of this invention, the system for recommending tourist attractions based on medical services further includes a setting module configured to set the medical degree parameters and the tour degree parameters.

According to another embodiment of this invention, the calculating module is further configured to analyze an input meaning, and the setting module is further configured to set the medical degree parameters and the tour degree parameters according to the analyzing result of the input meaning.

According to another embodiment of this invention, the calculating module is further configured to analyze an input meaning, and the setting module is further configured to determine whether the medical degree parameters and the tour degree parameters need to be set reversely according to the analyzing result of the input meaning.

According to another embodiment of this invention, the calculating module is further configured to analyze the input meaning to obtain at least one keyword, and the setting module is further configured to set the medical degree parameters and the tour degree parameters according to the keyword.

According to another embodiment of this invention, the medical degree parameters include a preset recovering time of operations, a preset notice item of foods and a preset notice item of tourism.

According to another embodiment of this invention, the tour degree parameters include a preset exercise degree parameter, a preset food degree parameter and a preset tour degree parameter.

Therefore, according to the technology of this invention, this invention provides a method and a system for recommending tourist attractions based on medical services to solve the problem of the conventional international medical service which may not recommend suitable tourist attractions according to the medical service.

Many of the attendant features and advantages of the present disclosure will becomes better understood with reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a flow chart of a method for recommending tourist attractions based on medical services according to embodiments of this invention;

FIG. 2 is a block diagram of a system for recommending tourist attractions based on medical services according to embodiments of this invention;

FIG. 3 is a schematic drawing of an application for recommending tourist attractions based on medical services according to embodiments of this invention;

FIG. 4 is a schematic drawing of an application for recommending tourist attractions based on medical services according to embodiments of this invention;

FIG. 5 is a schematic drawing of an application for recommending tourist attractions based on medical services according to embodiments of this invention; and

FIG. 6 is a schematic drawing of an application for recommending tourist attractions based on medical services according to embodiments of this invention.

In accordance with common practice, the various described features/elements are not drawn to scale but instead are drawn to best illustrate specific features/elements relevant to the present invention. Also, like reference numerals and designations in the various drawings are used to indicate like elements/parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the related art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

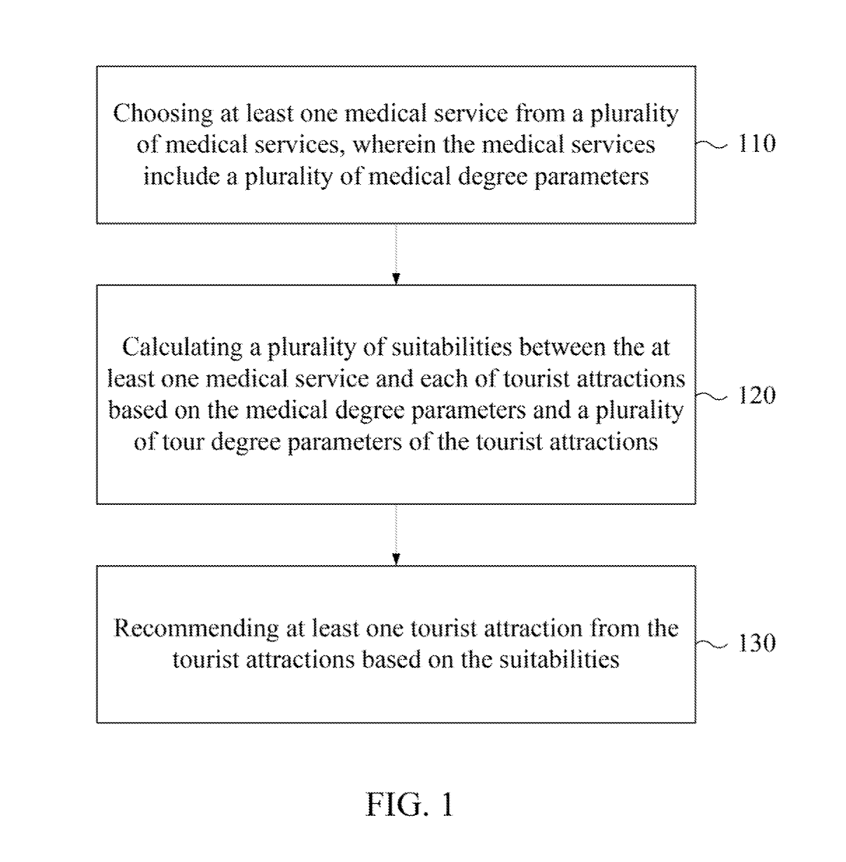

FIG. 1 is a flow chart of a method 100 for recommending tourist attractions based on medical services according to embodiments of this invention. As shown in FIG. 1, the method 100 for recommending tourist attractions based on medical services includes the steps as below:

Step 110: choosing at least one medical service from a plurality of medical services, wherein the medical services include a plurality of medical degree parameters;

Step 120: calculating a plurality of suitabilities between the at least one medical service and each of tourist attractions based on the medical degree parameters and a plurality of tour degree parameters of the tourist attractions; and

Step 130: recommending at least one tourist attraction from the tourist attractions based on the suitabilities.

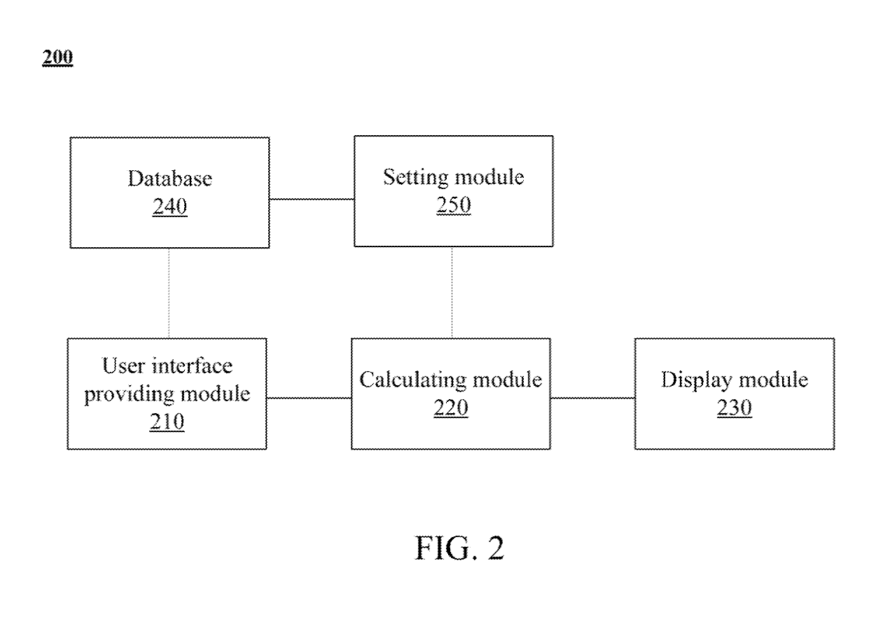

To clarify the method 100 for recommending tourist attractions based on medical services, please refer to FIG. 2. FIG. 2 is a block diagram of a system 200 for recommending tourist attractions based on medical services according to embodiments of this invention. The system 200 includes a user interface providing module 210, a calculating module 220, a display module 230, a database 240 and a setting module 250. The user interface providing module 210 is coupled to the calculating module 220 and the database 240. The calculating module 220 is coupled to the display module 230 and the setting module 250. The database 240 is coupled to the setting module 250. The method 100 for recommending tourist attractions based on medical services is illustrated below with reference made to the system 200.

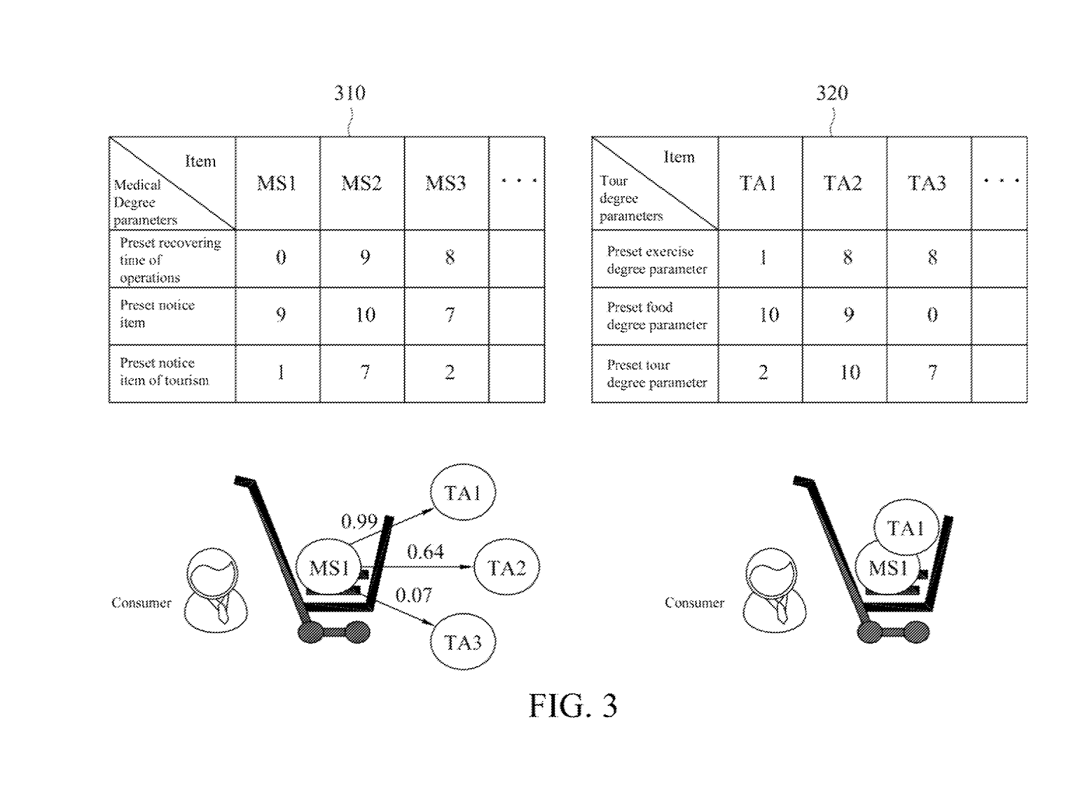

FIG. 3 is a schematic drawing of an application for recommending tourist attractions based on medical services according to further another embodiment of this invention. In step 110, a consumer may select at least one medical service from a plurality of medical services MS1˜MSn according to the table 310 of the user interface provided by the user interface providing module 210. For example, the consumer chooses the medical service MS1 from the table 310.

In this embodiment, the medical services include plural medical degree parameters, such as a preset recovering time of operations, a preset notice item of foods and a preset notice item of tourism as shown in the table 310. The medical degree parameters are determined by the degree of operations. Generally, when the degree of the operations is high, the medical degree parameter is increased respectively. For example, the degree of the cardiac surgery is high so that the medical degree parameter is increased respectively. The degree of the laser stain removal is low so that corresponding medical degree parameter is decreased respectively. However, this invention is not limited to the relation above. The medical degree parameter may depend on other considerations. Thus, the medical degree parameter may be determined according to real situation. In this embodiment, the highest value of the medical degree parameter is 10, and the lowest value of the medical degree parameter is 0. When the value of the medical degree parameter is near 10, it represents that the degree of the operation is high; on the contrary, it represents that the degree of the operation is low. However, the invention is not intended to be limited in this regard: the value of the medical degree parameter is merely used for illustratively introducing one embodiment of this invention.

For example, the medical service MS1 which the consumer selects can be a laser stain removal. As shown in table 310, the preset recovering time of the laser stain removal is very short. After the laser stain removal, the consumer bears less body burden. Therefore, the preset recovering time of operation may be set as zero. However, in order to prevent skin from pigementation after the laser stain removal, the consumer should pay attention to foods especially so that the preset notice item of foods may be set as nine. Furthermore, there are less notice items for consumer after the laser stain removal (e.g. preventing skin from water is not necessary), so the preset notice item of tourism may be set as one.

Accordingly, the tourist attractions TA1˜Tan may be displayed on the table 320 by the user interface provided by the user interface providing module 210. The tourist attractions include plural tour degree parameters, such as a preset exercise degree parameter, a preset food degree parameter, a preset tourism parameter, and so on as shown in table 320. The tour degree parameters are determined by the degree of tourism. Generally, when the physical exertion is great in tourism, the tour degree parameter is increased respectively; otherwise, the tour degree parameter is decreased. For example, the physical exertion is great for climbing the Himalayas, so the corresponding tour degree parameter is high. While, the physical exertion is low for visiting the temples, so the corresponding tour degree parameter is low. However, this invention is not limited to the relation above. The tour degree parameter may depend on other considerations. Thus, the tour degree parameter may be determined according to real situation. In this embodiment, the highest value of the tour degree parameter is 10, and the lowest value of the tour degree parameter is 0. When the value of the tour degree parameter is near 10, it represents that the degree of the physical exertion is great; on the contrary, it represents that the degree of the physical exertion is low. However, the invention is not intended to be limited in this regard; the value of the tour degree parameter is merely used for illustratively introducing one embodiment of this invention.

For example, the tourist attraction TA1 is visiting temples, and the physical exertion is low for visiting the temples as shown in table 320. Thus, the preset exercise degree parameter may be set as one. However, because a fast is necessary during visiting temples, the preset food degree parameter may be set as ten. Moreover, there are less notice items during visiting temples (Referring to the medical service above, preventing from water is necessary after operation. While, the consumer may not contact water during visiting temples), so the preset tour degree parameter may be set as two.

In one embodiment, as shown in table 310, the medical degree parameters include the preset recovering time of operations, the preset notice item of foods and the preset notice item of tourism, and so on. The professional medical personnel may set these parameters through the setting module 250 according to his/her medical experience. Besides, as shown in table 320, the tour degree parameters include the preset exercise degree parameter, the preset food degree parameter, the preset tourism parameter, and so on. The professional travel agent may set these parameters through the setting module 250 according to his/her tourism experience.

Then, please refer to FIG. 1 and FIG. 2. In step 120, the suitability between the medical service MS1 chosen by the consumer and each of the tourist attractions may be calculated by the calculating module 220 according to the medical degree parameters and the tour degree parameters above. An example is illustrated herein to explain the calculating method of the suitability. Please refer to the formula 1 as below:

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad formula 1$$

“Similarity” of formula 1 means the suitability, A is the value of the medical degree parameter of the table 310 in FIG. 3, and B is the value of the tour degree parameter of the table 320 in FIG. 3. The results which the medical service MS1 and the tourist attractions TA1 in FIG. 3 are calculated by the formula 1 are listed in table 1 as below.

TABLE 1
The results of formula 1

| | Item/calculation | | | | |
|---|---|---|---|---|---|
| Item | MS1 (A) | TA1 (B) | A × B | A2 | B2 |
| Recovering time of | 0 | 1 | 0 | 0 | 1 |
| operations/exercise | | | | | |
| degree parameter | | | | | |
| Notice item of foods/ | 9 | 10 | 90 | 81 | 100 |
| food degree | | | | | |
| parameter | | | | | |
| Notice item of tourism/ | 1 | 2 | 2 | 1 | 4 |
| tour degree | | | | | |
| parameter | | | | | |
| total | | | 92 | 82 | 105 |

| | |
|---|---|
| Suitability | 0.99 |

The medical degree parameter of the medical service MS1 and the tour degree parameter of the tourist attraction TA1 are listed in the left part of Table 1. The calculation item and results of formula 1 are listed in the right part of Table 1, The summations of calculation item are listed at the lower part of Table 1. The value of the suitability is calculated as 0.99. Similarly, the suitability of medical service MS1 and tourist attraction TA2 is calculated as 0.64. The suitability of medical service MS1 and tourist attraction TA3 is calculated as 0.07. The suitability between medical service MS1 and each of tourist attractions is shown in FIG. 3. The suitability indicates if the corresponding tourist attraction is adapted to the medical service MS1. In this embodiment, the highest value of suitability is one and the lowest value thereof is zero. When the suitability is more closed to one, the corresponding tourist attraction is more adapted to the medical service MS1. Otherwise, it indicates that the tourist attraction is not suitable to the medical service. However, this invention is not limited to the representation above. The value of suitability above is merely illustrated one implement of this invention. In another embodiment, the suitability may be described in percentage.

Please refer to FIG. 1 and FIG. 2. In step 130, after the suitability between medical service MS1 and each of tourist attractions is obtained, one of the tourist attractions TA1˜TA3 may be recommended and displayed by the display module 230 according to the suitabilities. Accordingly, the consumer may be aware of the suitable tourist attraction for the medical service according to the method 100 for recommending tourist attractions based on medical vices. Moreover, the method 100 above possesses the advantages of simplicity, quickness, intuition so that the user may select the suitable tourist attraction for the medical service efficiently. This method may satisfy the requirements of medical service and tourism.

In one embodiment, for step 130, the tourist attraction with the highest suitability may be recommended by the display module 230 according to the suitabilities above. For example, when the consumer chooses the medical service MS1, the tourist attraction TA1 with the highest suitability may be recommended. The object to recommend the most suitable tourist attraction for the medical service rapidly is accomplished. In another embodiment, in step 130 the tourist attractions may be sorted by the value of the suitability, and be listed in a tourist attraction table to provide full information for the consumer. Then, the consumer may select preferred tourist attraction from the tourist attraction table. However, the embodiments above are only some representations for implements, and they are not tended to limit this invention.

In another embodiment, the method 100 for recommending tourist attractions based on medical services further includes establishing a database to store the medical services and the tourist attractions. As mentioned above, in FIG. 3, the medical degree parameters of medical services in the table 310 and the tour degree parameters of tour attractions in the table 320 may be set by the professional medical personnel and the professional travel agent. The medical service and the tour attraction with set parameters may be stored in the database 240 as shown in FIG. 2.

In further another embodiment, in the step of setting the medical degree parameters and the tour degree parameters, in practice, the professional medical personnel and the professional travel agent may input a description. The input description is analyzed by the calculating module 220 so that the input meaning is obtained, and the medical degree parameters and the tour degree parameters are set by the setting module 250. The input meaning is defined as the meaning of the input description. For example, the professional medical personnel may input a description as “The recovering time of laser stain removal is short, it is necessary to pay attention to food, and there are relatively few other notice item.” Then, the input meaning analysis of the input description is proceeded by the calculating module 220, and the analysis result is utilized to set the medical degree parameters. For example, the analysis results from the calculating module 220 are: the preset recovering time of operations is low, the preset notice item of foods is relatively high and the preset notice item of tourism is low. According the analysis results, the setting module 250 set the preset recovering time of operations as zero, the preset notice item of foods as nine and the preset notice item of tourism as one. The setting of the tour degree parameters is similar to that of the medical degree parameters, so it is not repeated herein.

In yet another embodiment, in the step of setting the medical degree parameters and the tour degree parameters, the professional medical personnel may input description in reverse form. For example, the professional medical personnel may input a description as “The recovering time of the laser stain removal is short, attention for food cannot be ignored, and there are relatively few other notice item”. In this case, if the calculating module 220 only analyzes the input meaning of “ignoring food,” and the notice item of food may be low according to the analysis result. The setting module 250 may set the preset notice item of foods as 1 respectively. However, the setting above is incorrect.

Accordingly, the calculating module 220 may further analyze if the input meaning of the input description contains reverse forms so that if the medical degree parameters and the tour degree parameters are set reversely by the setting module 250 or not is determined. If the input description contains a reverse form, the calculating module 220 commands the setting module 250 to reversely set the preset notice item of foods as nine. However, the reverse setting above is only one implement of this invention, and it is not tended to limit this invention.

Referring to another embodiment, in the step of setting the medical degree parameters and the tour degree parameters, the input meaning is analyzed by the calculating module 220 to obtain at least one key word. The medical degree parameters and the tour degree parameters are set according to the key word. For example, the professional medical personnel may input a description as “The recovering time of the laser stain removal is short, it is necessary to pay attention to food, and there are relatively few other notice item.” Then, the input meaning analysis of the input description is proceeded by the calculating module 220, and the key words “recovering time” and “short” are obtained. The setting module 250 sets the preset recovering time of operations as zero according to the key words respectively. The preset notice item of foods and the preset notice item of tourism may be set by the way above. However, the setting method above is only one implement of this invention, and it is not tended to limit this invention.

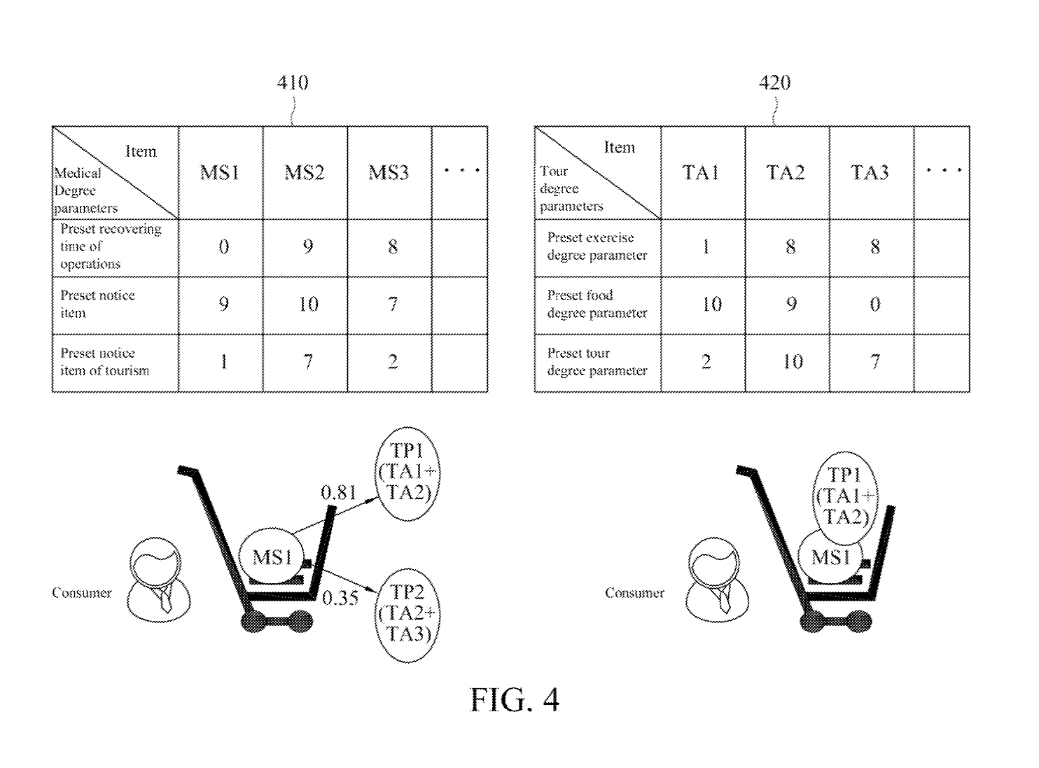

FIG. 4 is a schematic drawing of an application for recommending tourist attractions based on medical services according to yet another embodiment of this invention. First, after the consumer selects the medical service MS1, the consumer may be interested in more than two tourist attractions. Therefore, the method 100 for recommending tourist attractions based on medical services may arrange plural tourist attractions to a tour package TP. Then, the suitabilities between the medical service MS1 and the tour packages TP1˜TPn are calculated by the method 100. For example, the suitability of the medical service MS1 and the tour package TP1 is 0.81, and the suitability of the medical service MS1 and the tour package TP2 is 0.35. At least one tour package of the tour packages TP1˜TPn may be recommended.

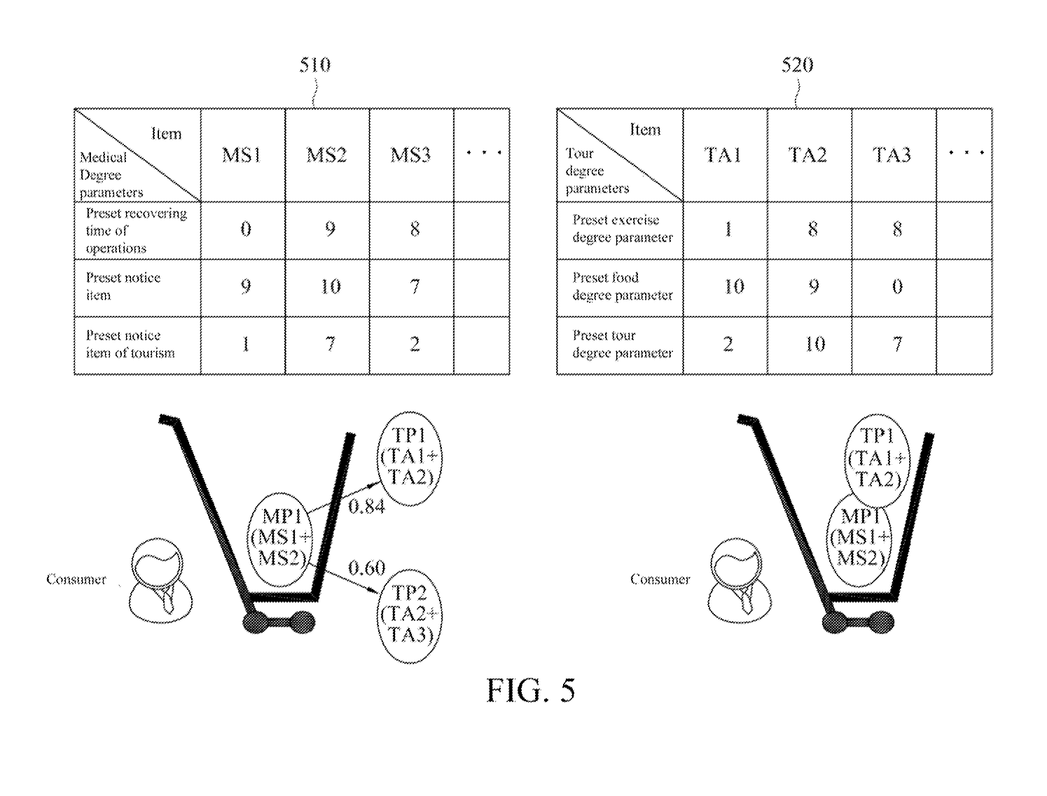

FIG. 5 is a schematic drawing of an application for recommending tourist attractions based on medical services according to another embodiment of this invention. First, the consumer may select plural medical services MS at one time. Therefore, the method 100 for recommending tourist attractions based on medical services may arrange plural medical services to a medical package MP. Then, the suitabilities between the medical package MP and the tour packages TP1˜TPn are calculated by the method 100. For example, the suitability of the medical package MP1 and the tour package TP1 is 0.84, and the suitability of the medical package MP1 and the tour package TP2 is 0.60. At least one tour package of the tour packages TP1˜TPn may be recommended.

In the embodiments in FIG. 4 and FIG. 5, when the consumer selects the medical service MS1 or the medical package MP1, the method 100 for recommending tourist attractions based on medical services may recommend the tour package TP1 with the highest suitability. Otherwise, the tour packages may be sorted by the suitabilities and listed in a tour package table. Accordingly, the consumer may be aware of more detail information from the method 100 and the method 100 help the consumer to select preferred tour package.

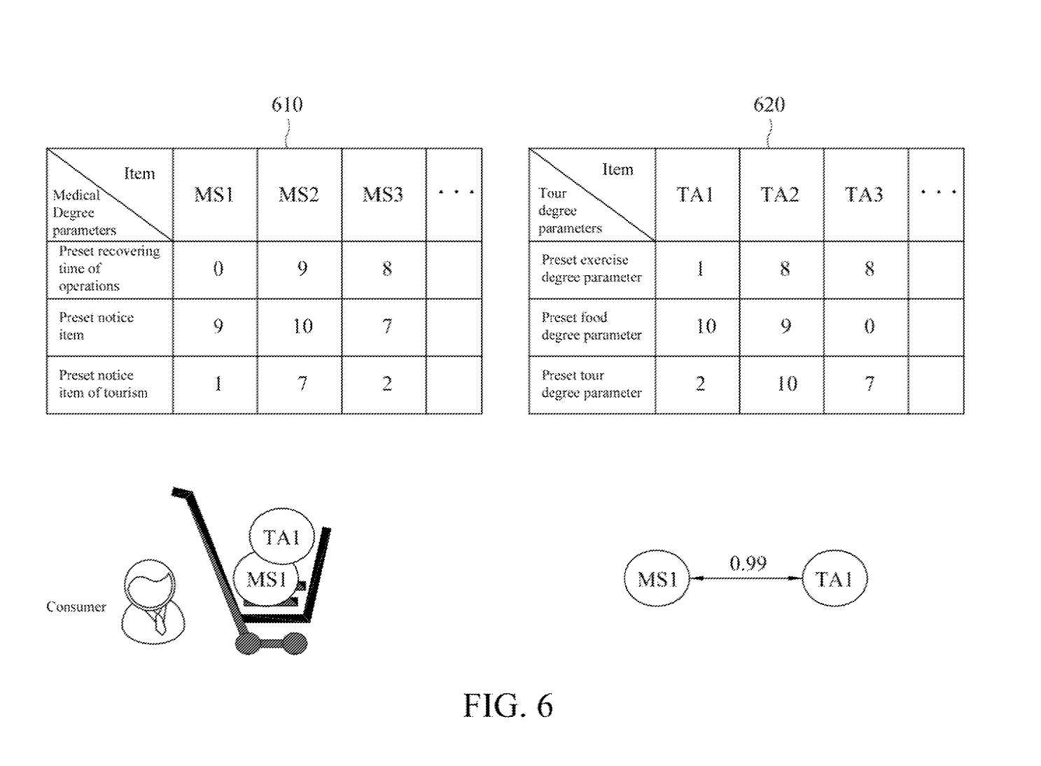

FIG. 6 is a schematic drawing of an application for recommending tourist attractions based on medical services according to further another embodiment of this invention. The method 100 for recommending tourist attractions based on medical services further includes the steps as below:

choosing at least one tourist attraction from the tourist attractions;

calculating suitability between the chosen medical service and the chosen tourist attraction; and

displaying the suitability between the chosen medical service and the chosen tourist attraction.

As shown in FIG. 6, from the table 610 of the user interface provided by the user interface providing module 210, the consumer may choose the medical service MS1 of medical services MS1˜MSn, and choose the tourist attraction TA1 of tourist attractions TA1˜TAn. Then, the suitability between the medical service MS1 and the tourist attraction TA1 may be calculated by the calculating module 220. The suitability between the medical service MS1 and the tourist attraction TA1 may be displayed by the display module 230 and the suitability is 0.99. Therefore, the consumer may be aware of the suitability between the medical service and the tourist attraction clearly.

Similarly, the consumer may select plural medical services MS at one time and the consumer may be interested in more than two tourist attractions TA. Therefore, the method 100 for recommending tourist attractions based on medical services may arrange plural tourist attractions TA to tour packages TP and arrange plural medical services MS to medical packages MP. Accordingly, the consumer may choose one of medical services MS or medical packages MP and choose one of the tourist attractions TA or tour packages TP. The suitability between the medical service/medical package and the tourist attraction tour package may be displayed by the method 100 and for consumer's reference. The suitabilities between the medical service/medical package and the tourist attraction/tour package are listed in Table 2 as below.

TABLE 2
The list of the suitablities

| suitabilit | | | | MP1 | MP2 |
|---|---|---|---|---|---|
| item | MS1 | MS2 | MS3 | (MS1 + MS2) | (MS2 + MS3) |
| TA1 | 0.99 | 0.79 | 0.73 | 0.89 | 0.76 |
| TA2 | 0.64 | 0.97 | 0.86 | 0.80 | 0.91 |
| TA3 | 0.07 | 0.75 | 0.67 | 0.41 | 0.71 |
| TP1 | 0.81 | 0.88 | 0.79 | 0.84 | 0.83 |
| (TA1 + TA2) | | | | | |
| TP2 | 0.35 | 0.86 | 0.76 | 0.60 | 0.81 |
| (TA2 + TA3) | | | | | |

The method 100 for recommending tourist attractions based on medical services may be implemented by software, hardware and/or firmware. For example, if the major concern is executing speed and precision, hardware and/or firmware may be preferred basically. If the major concern is the flexibility of design, software may be preferred basically. Furthermore, software, hardware and firmware may be integrated. It should be understood that the description of the examples above does not imply the priority therebetween, and is not intended to limit the scope of this invention. The person skilled in the art may make any amendment depending on the requirement.

Moreover, the person with ordinary knowledge in the art should realize that to clarify the technology of this invention, the steps of the method 100 for recommending tourist attractions based on medical services are named by their functions but not tended to limit themselves. These steps may be integrated or be divided into several steps, or any step may be executed in another step. These changes should fall into the scope of this invention.

According to embodiments of this invention, this invention has many advantages. This invention provides the method 100 and the system 200 for recommending tourist attractions based on medical services to solve the problem of the conventional international medical service which may not recommend suitable tourist attractions according to the medical service.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for recommending tourist attractions based on medical services, comprising:
choosing at least one medical service from a plurality of medical services, wherein the medical services include a plurality of medical degree parameters;
calculating a plurality of suitabilities between the at least one medical service and each of tourist attractions based on the medical degree parameters and a plurality of tour degree parameters of the tourist attractions; and
recommending at least one tourist attraction from the tourist attractions based on the suitabilities.

2. The method of claim 1, wherein the step of recommending at least one tourist attraction from the tourist attractions based on the suitabilities further comprises:
recommending the tourist attraction with the highest suitability based on the suitabilities.

3. The method of claim 1, further comprising:
establishing a database to store the medical services and the tourist attractions.

4. The method of claim 1, further comprising:
choosing at least one tourist attraction from the tourist attractions;
calculating a suitability between the at least one medical service which is chosen and the at least one tourist attraction which is chosen; and
displaying the suitability between the at least one medical service which is chosen and the at least one tourist attraction which is chosen.

5. The method of claim 1, further comprising:
setting the medical degree parameters and the tour degree parameters.

6. The method of claim 5, wherein the step of setting the medical degree parameters and the tour degree parameters comprises:
analyzing an input meaning to set the medical degree parameters and the tour degree parameters.

7. The method of claim 5, wherein the step of setting the medical degree parameters and the tour degree parameters comprises:
analyzing an input meaning to determine whether the medical degree parameters and the tour degree parameters need to be set reversely.

8. The method of claim 5, wherein the step of setting the medical degree parameters and the tour degree parameters comprises;
analyzing an input meaning to obtain at least one keyword, and setting the medical degree parameters and the tour degree parameters according to the keyword.

9. The method of claim 1, wherein the medical degree parameters comprise a preset recovering time of operations, a preset notice item of foods and a preset notice item of tourism.

10. The method of claim 1, wherein the tour degree parameters comprise a preset exercise degree parameter, a preset food degree parameter and a preset tour degree parameter.

11. A system for recommending tourist attractions based on medical services, comprising:
a user interface providing module, configured to provide a user interface comprising a plurality of medical services for selecting at least one of the medical services from the user interface, and wherein the medical services include a plurality of medical degree parameters;
a calculating module, configured to calculate a plurality of suitabilities between the at least one medical service and each of tourist attractions based on the medical degree parameters and a plurality of tour degree parameters of the tourist attractions; and
a display module, configured to display and recommend at least one tourist attraction from the tourist attractions based on the suitabilities.

12. The system of claim 11, wherein the display module is further configured to recommend the tourist attraction with the highest suitability based on the suitabilities.

13. The system of claim 11, further comprising:
a database, configured to store the medical services and the tourist attractions.

14. The system of claim 11, wherein the user interface providing module is further configured to let a user choose at least one of the tourist attractions, wherein the calculating module is further configured to calculate the suitability between the at least one medical service which is chosen and the at least one tourist attraction which is chosen and wherein the display module is further configured to display the suitability between the at least one medical service which is chosen and the at least one tourist attraction which is chosen.

15. The system of claim 11, further comprising:
a setting module, configured to set the medical degree parameters and the tour degree parameters.

16. The system of claim 15, wherein the calculating module is further configured to analyze an input meaning, and wherein the setting module is further configured to set the medical degree parameters and the tour degree parameters according to the analyzing result of the input meaning.

17. The system of claim 15, wherein the calculating module is further configured to analyze an input meaning, and wherein the setting module is further configured to determine whether the medical degree parameters and the tour degree parameters need to be set reversely according to the analyzing result of the input meaning.

18. The system of claim 15, wherein the calculating module is further configured to analyze an input meaning to obtain at least one keyword, and wherein the setting module is further configured to set the medical degree parameters and the tour degree parameters according to the keyword.

19. The system of claim 11, wherein the medical degree parameters comprise a preset recovering time of operations, a preset notice item of foods and a preset notice item of tourism.

20. The system of claim 11, wherein the tour degree parameters comprise a preset exercise degree parameter, a preset food degree parameter and a preset tour degree parameter.
